(19) United States
(12) Patent Application Publication
(10) Pub. No.: US 2018/0253656 A1
(43) Pub. Date: Sep. 6, 2018

(54) FUZZY LOGIC BASED RESENDING ORDER OF NOT SUCCESSFULLY PROCESSED REQUESTS

(71) Applicants: Plamen Valentinov Ivanov, Sofia (BG); Lozan LOZANOV, Sofia (BG); ENTIT SOFTWARE LLC, SANFORD, NC (US)

(72) Inventors: Plamen Valentinov Ivanov, Sofia (BG); Lozen Lozanov, Sofia (BG)

(21) Appl. No.: 15/771,016

(22) PCT Filed: Oct. 30, 2015
(86) PCT No.: PCT/EP2015/075303

§ 371 Date: Apr. 25, 2018

(51) Int. Cl. G06N 5/04

(52) U.S. Cl. CPC G06N 5/048

(57) ABSTRACT

Provided is a process in which a plurality of requests is sent from an interface of a first device to an interface of a second device. If it is determined that at least some of the plurality of requests have not successfully been processed by the second device, an order of at least some of the not successfully processed requests is determined for resending, wherein the order is based on a fuzzy logic implementation.

Communicatively coupled devices may exchange requests that are to be processed by the receiving device. However, in case of requests being not successfully processed, mechanisms for handling said requests may be used.

### BRIEF DESCRIPTION OF DRAWINGS

The following detailed description refers to the appended drawings in which:

FIG. 1 schematically illustrates a system comprising a first device and a second device exchanging requests via interfaces;

FIG. 2 is a flow diagram illustrating an example of reordering not (successfully) processed requests in the system of FIG. 1;

FIG. 3 is a flow diagram illustrating another example of reordering not (successfully) processed requests in the system of FIG. 1; and

FIG. 4 is a flow diagram illustrating an example of a fuzzy logic engine that may be used in the reordering process.

### DETAILED DESCRIPTION

Many communicatively coupled devices do not comprise out of the box mechanisms for automatic communication recovery in case that requests sent from a device to another device are not successfully processed by the other device. Instead, mechanisms for automatic communication recovery may be built on custom approaches which may involve additional development effort and are prone to design errors. Accordingly, the present disclosure provides, for example, techniques for reordering not successfully processed requests based on fuzzy logic. In this regard, it is noted that the expression “not successfully processed” as used throughout the specification and claims is intended to cover requests that are not processed, e.g., where processing has not even started, such as, for example, in case of a transmission fault occurring when requests are transmitted between devices via a potentially unreliable transmission medium, or where processing started but failed before completion.

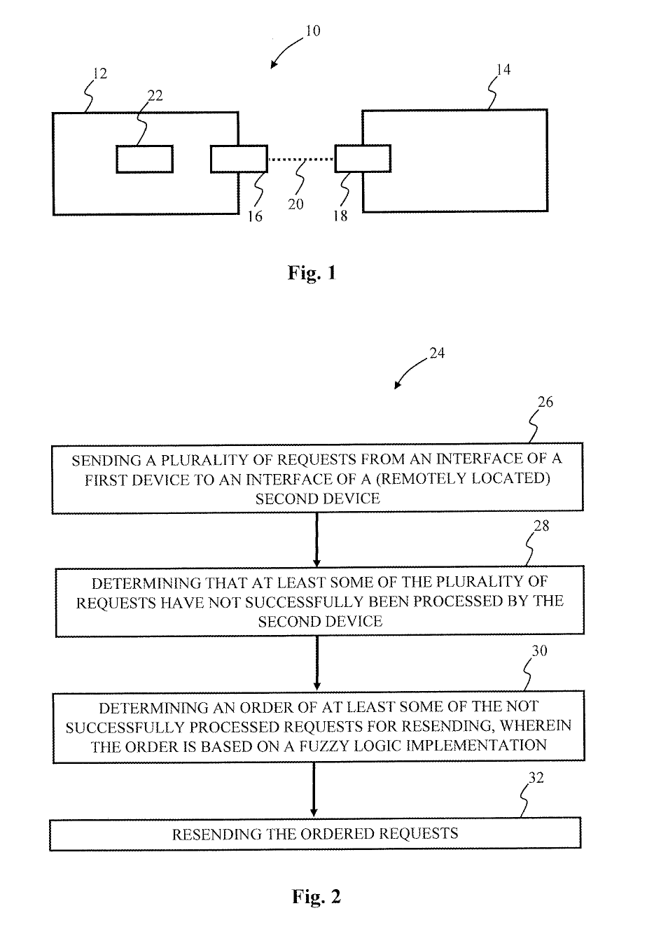

FIG. 1 schematically illustrates a system 10 comprising a first device 12 and a second device 14 that are communicatively coupled. For example, the first device 12 and the second device 14 may be computing devices (desktop computers, laptop computers, servers, handheld computing devices, etc.). The first device 12 may host an information technology (IT) service management application that manages records stored in a memory of the second device 14. To manage the records stored in a memory of the second device 14, the first device 12 may send a plurality of requests via a first interface 16 of the first device 12 to the second device 14. The requests may be received by the second device 14 via a second interface 18 of the second device 14 and the second device 14 may handle the records in accordance with the received requests. Thus, in more general terms, each request may be directed at an action to be performed by the second device 14. The action may be related to the creation, deletion, change or another operation on an entity which is stored in a memory of the second device 14, such as creating, deleting, updating, closing, reopening, etc. a record in the memory of the second device 14.

The first interface 16 and the second interface 18 may be implemented by hardware, persistently stored machine-readable instructions, or a combination thereof. For example, the first interface 16 and the second interface 18 may be implemented by hardware circuitry implementing logic, or a processor and a non-transitory machine-readable medium coupled to the processor and storing instructions that are to be executed by the processor. Moreover, the first interface 16 and the second interface 18 may be connected via a communication link 20 through which electric signals may be exchanged. For example, the communication link 20 may be a wired or wireless communication connection in which binary data may be transmitted in encoded form. The second device 14 may be remotely located with respect to the first device 12. In this regard, it is noted that the term “remotely located” as used throughout the description and the claims is intended to be interpreted broadly and may indicate that the first device 12 and the second device 14 are separate entities that do neither share common hardware resources nor a common housing. Moreover, the term “remotely located” may indicate that the first device 12 and the second device 14 are located at different premises, although the disclosure is not so limited.

The communication connection 20 may be network-based, e.g., internet-based. Moreover, the communication connection 20 may comprise a transmission node that relays data traffic between the first interface 16 and the second interface 18. The transmission node may be involved in wireless transmission of electric signals such as, for instance, in a wireless local area network (W-LAN, etc.) or a cellular network like long term evolution (LTE). In case that the communication connection 20 is unreliable or that the second device 14 experiences an overload condition, a malfunction, etc., a request sent by the first device 12 via the first interface 16 may not be replied by the second device 14 with a reply message indicating that the request has been performed successfully. For example, when the request is directed at a “Create”, “Delete”, “Update”, “Close”, “Reopen”, etc. action with regard to a record in the second device 14, the second device 14 may respond by signaling a status value such as a “Success” status value if the action has been performed successfully, or a “Failed” status value if the action has not been performed (e.g., due to the second device 14 not having received the request due to the unreliable communication connection 20) or has not been performed successfully. Moreover, the first device 12 may have a clock triggering a timeout after which the first device 12 assumes that the respective action has not been performed by the second device 14. In this regard it is noted that the timeout may occur if the communication connection 20 fails, i.e., the second device 14 does not receive the request from the first device, the first device 12 does not receive the status value from the second device 14, or if the second device 14 fails in correctly operating the request in time.

In case that a request has not been successfully processed, the first interface 12 may signal descriptive information about the request to a fuzzy logic implementation 22. The fuzzy logic implementation 22 may comprise a fuzzy logic engine implemented by hardware, persistently stored machine-readable instructions, or a combination thereof. The fuzzy logic engine may persistently store fuzzy membership functions (e.g., a triangular, sinusoidal, or trapezoidal membership functions) and fuzzy inference rules (e.g., bivalent “if-then” rules) and apply them to crisp (i.e. bivalent, numerical) values derived from the descriptive information. For example, the fuzzy logic engine may be implemented by hardware circuitry implementing logic, or a processor and a non-transitory machine-readable medium coupled to the processor and storing instructions that are to be executed by the processor. The descriptive information may contain an indication of an urgency of the respective request, an indication of a category of the respective request, an indication of a number of not, or not successfully processed requests in the same category, or a combination thereof. The fuzzy logic engine may map the crisp values to the membership functions and apply the fuzzy inference rules to the fuzzy values derived from the mapping to calculate the membership in regard to the respective fuzzy sets. The fuzzy logic engine may then perform a defuzzification and calculate linguistic and crisp output values.

An indication of the linguistic and crisp output values, i.e., the linguistic output value, the crisp output value, or a value derived from the linguistic and crisp output values may then be provided as ordering information to the first interface 12. The first interface 12 may receive ordering information for a plurality of (or all) requests that have not been successfully processed by the second device 14, from the fuzzy logic engine and order the requests in accordance with the ordering information. In particular, the first interface 12 may change a current order or an order in which the requests were initially sent. The first interface 12 may then resend the ordered requests to the second interface 18 of the second device 14.

As shown in FIG. 2, a process 24 of reordering not successfully processed requests implemented in the first device 12 may start at 26, where the first device 12 sends a plurality of requests from the first interface 16 of the first device 12 to the second interface 18 of the (remotely located) second device 14. At 28, the process 24 continues in that the first interface 16 determines that at least some of the plurality of requests have not successfully been processed by the second device 14. For example, the first interface 16 may receive respective indications in form of status values from the second interface 18 of the second device 14. In addition, the first interface 16 of the first device 12 may treat requests for which no status value was received within a predefined time period as if a status value indicating that the request has failed had been received. At 30, the process 24 may continue with determining an order of at least some of the not successfully processed requests for resending, wherein the order is based on the fuzzy logic implementation 22.

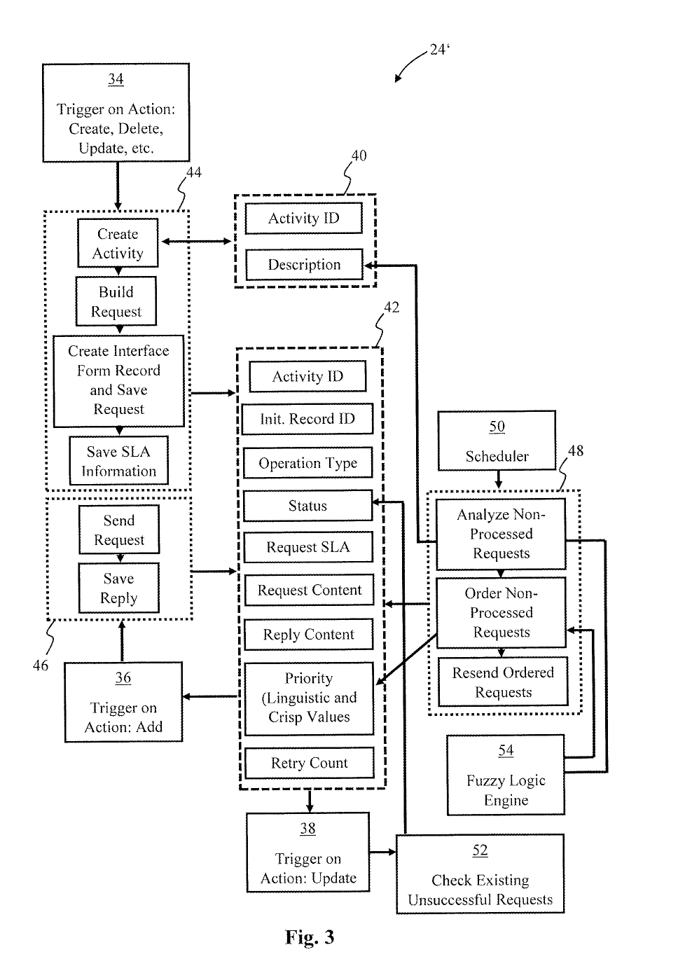

FIG. 3 is a flow diagram illustrating another example 24′ of reordering not successfully processed requests in the system shown in FIG. 1. The actions performed by the process shown in FIG. 3 are initiated when a respective trigger of one of three triggers 34, 36, 38 is fired and calls the respective actions. Each of the three triggers 34, 36, 38 may be implemented in the first device 12 by persistently stored machine-readable instructions, hardware, or a combination thereof. The first trigger 34 may be initiated by a user of the first device 12 or a workflow within the first device 12 performing an action of a list of predefined actions. For example, the list of predefined actions may comprise actions like “Create”, “Delete”, “Update”, “Close”, “Reopen”, etc. a record in a memory of the second device 14. The second trigger 36 may be initiated by the workflow performing an “Add” action with regard to a record in an activity form 40 which may be persistently stored in a non-transitory machine-readable medium of the first device 12. The third trigger 38 may be initiated by the workflow performing an “Update” action with regard to a record in an interface form 42 comprising the descriptive information about requests which may be persistently stored in the first interface 16 of the first device 12.

The first device 12 comprises three code blocks 44, 46, 48 which implement logic to perform the actions which are called by the first to third trigger 34, 36, 38. As indicated in FIG. 3, the actions may be performed in a specific order. However, the order of execution may be changed and it is noted that the disclosure is not limited in this regard. Moreover, it is noted that the implementation of the logic may be based on various programming/scripting languages. Along with the actual assembly of the request and execution handling, the code blocks 44, 46, 48 are interfacing with the activity form 40, the interface foul′ 42, and a scheduler 50. The first code block 44 may implement logic to create a new activity record in the activity form 40 which may store a plurality of unique records, each record representing activity details of a request to be sent to and performed by the second device 14. Each record in the activity foal′ 40 may comprise an “Activity Id” field and a “Description” field which may be created and populated during execution of the “Create Activity” action implemented by the first code block 44. A value stored in the “Activity ID” field may uniquely identify the activity. The “Description” field of the activity may be updated upon every subsequent retry with regard to execution of the request represented by the respective record until a successful operation of the request by the second device 14 is recorded.

The “Activity ID” associates each record in the activity form 40 with a corresponding record in the interface form 42. The record in the interface form 42 may store information that is relevant to the respective activity. For example, each record in the interface form 42 may comprise an “Activity ID” field which is populated during execution of the “Create Interface Form Record and Save Request” action implemented by the first code block 44, which may be performed after the request to be sent to the second device 14 has been built during the “Build Request” action implemented by the first code block 44. Moreover, the “Create Interface Form Record and Save Request” action implemented by the first code block 44 may populate the “Operation Type” field of the respective record in the interface form 42 with an indication of the operation type of the request such as “Create”, “Delete”, “Update”, “Close”, “Reopen”, etc., wherein the operation type indicates that the activity is related to a specific category such as creating, deleting, updating, closing, reopening, etc. a record in the memory of the second device 14. Each record in the interface form 42 may further comprise an “Initializing Record Id” field which stores a value identifying an initializing record. For example, the initializing record may identify an event to which multiple requests relate.

Each record on the interface form 42 may comprise a “Status” field which stores an indication of the request status and may include values like “Success” or “Failed”. Initially the value of the “Status” field may be set by the “Save Reply” action implemented by the second code block 46. For example, if a request has failed and resending of the request is to be performed, the value of the “Status” field may be set to “Failed” and may consecutively be updated by the “Check Existing Unsuccessful Requests” action 52. In case the communication between the first interface 16 of the first device 12 and the second interface 18 of the second device 14 is based on Simple Object Access Protocol (SOAP) and Web Services standards, the reply may be a SOAP XML message, a SOAP fault, an HTTP status code, a Java exception code, etc.

Each record in the interface form 42 may further comprise a “Request SLA” (Service Level Agreement) field which stores an indication of an agreed upon execution time according to a Service Level Agreement between an operator of the first device 12 (representing a Service Provider) and a customer (i.e., a customer of the services provided by the Service Provider) using the second interface 18. For example, times for executing particular requests can be negotiated and stored in the “Request SLA” field (for example, the “Create” operation should be successfully processed within 15 seconds; the “Update” operation should be successfully performed within 30 seconds; etc.). The agreement may be negotiated via the first interface 16 or the conditions of the agreement may be downloaded from a database which is communicatively connected to the first device 12. The value of the “Request SLA” field may be set by the “Save SLA Information” action implemented by the first code block 44. Each record in the interface form 42 may further comprise a “Request Content” field that stores the request. This field may be populated during execution of the “Create Interface Form Record and Save Request” action implemented by the first code block 44. If the request is not (successfully) processed (failed) the content of said field may be used by the “Resend Ordered Requests” action implemented by the third code block 48, to resend the failed request. Each record in the interface form 42 may further comprise a “Reply Content” field which stores the reply received in response to the request. Initially, this field may be populated by the “Save Reply” action implemented by the second code block 46. If the request is not (successfully) processed, the field may be updated during the “Resend Ordered Requests” action implemented by the third code block 48.

Each record in the interface form 42 may further comprise a “Priority” field which stores ordering information (e.g., linguistic and crisp values) provided by the fuzzy logic engine 54 for some or all failed requests. The content of this field may be updated on each retry processing cycle triggered by the scheduler 50, calling actions of the third code block 48 comprising the “Order Non Processed Records” action. The scheduler 50 may call on the actions of the third code block 48 in accordance with a predetermined schedule. For example, the scheduler 50 may call the actions of the third code block 48 at predetermined time intervals. The “Analyze Non Processed Requests” action implemented by the third code block 48 may (when called) provide descriptive information with regard to failed requests to the fuzzy logic engine 54. For example, the descriptive information may comprise the content of one or more fields of the interface form 42 record. After processing the descriptive information, the fuzzy logic engine 54 may provide the ordering information that may be used by the “Order Non Processed Requests” action implemented by the third code block 48 to order the failed requests for resending during the “Resend Ordered Requests” action implemented by the third code block 48. Each record in the interface form 42 may further comprise a “Retry Count” field which stores the number of retry operations performed on the failed request. Initially this field may be set by the “Create Interface Form Record and Save Request” action of the first code block 44. If the request is not successfully processed (failed), this field may be updated by the “Resend Ordered Requests” action of the third code block 48.

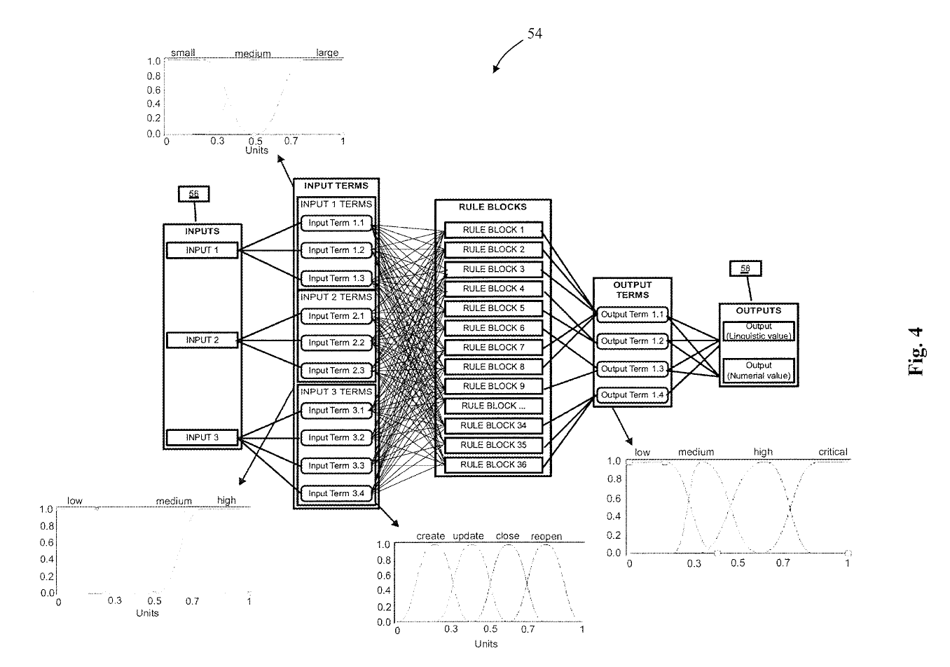

FIG. 4 is a flow diagram illustrating an example of the fuzzy logic engine 54 that may be used in the reordering process 24, 24′. The fuzzy logic engine 54 may receive descriptive information 56 with regard to records of the interface form 44 whose “Status” field is populated with a value that is different from “Success” as input and provide ordering information 58 as output. The descriptive information 56 may be analyzed by the fuzzy logic engine 54, based on previously defined and implemented expert knowledge including linguistic input terms and corresponding triangular, sinusoidal, or trapezoidal membership functions that map the descriptive information for each linguistic input term to membership values describing a degree with which the descriptive information corresponds to the respective linguistic input terms. For example, the descriptive information may comprise a crisp “Impact” value indicating the number of other failed requests with the same “Operation Type” (category). The linguistic input terms on which the “Impact” value is to be mapped may comprise the linguistic input ten is “small”, “medium”, and “large”.

Furthermore, the descriptive information may comprise a crisp “Urgency” value indicating the agreed upon execution times defined in the SLAs. The linguistic input terms on which the “Urgency” value is to be mapped may comprise the linguistic input terms “low”, “medium”, and “high”. Moreover, the descriptive information may comprise a crisp “Operation Type” value indicating the category of the respective request. The linguistic input teams on which the “Operation Type” value is to be mapped may comprise the linguistic input turns “create”, “update”, “close”, and “reopen”. The fuzzy logic engine 54 may further comprise a plurality of rules mapping the linguistic input terms to linguistic output terms such as, for example, “critical”, “high”, “medium”, and “low” and a rule aggregation logic which allows to determine a degree with which the descriptive information corresponds to each linguistic output term. Each output term may be associated with a triangular, sinusoidal, or trapezoidal membership function allowing to calculate a crisp output value from the degrees with which the descriptive information corresponds to the linguistic output terms. Based on the output of the fuzzy logic engine 54, all non-processed records may be sorted for resending. The sorting may be based on the linguistic output value or the numerical output value which allows to sort the records with increased accuracy.

1. A computer-implemented method, comprising:
sending a plurality of requests from an interface of a first device to an interface of a remotely located second device;
determining that at least some of the plurality of requests have not successfully been processed by the second device;
determining an order of at least some of the not successfully processed requests for resending, wherein the order is based on a fuzzy logic implementation; and
resending the ordered requests.

2. The computer-implemented method of claim 1, wherein the requests are ordered based on crisp values calculated by the fuzzy logic implementation.

3. The computer-implemented method of claim 1, wherein a crisp value mapped on a plurality of membership functions of each request is based on a value indicating an urgency of the respective request.

4. The computer-implemented method of claim 1, wherein a crisp value mapped on a plurality of membership functions of each request is based on an indication of a category of the respective request.

5. The computer-implemented method of claim 1, wherein a crisp value mapped on a plurality of membership functions of each request is based on a number of not successfully processed requests in the same category.

6. The computer-implemented method of claim 1, wherein a crisp value mapped on a plurality of membership functions of each request is calculated based on a number of times the request was resent.

7. The computer-implemented method of claim 1, wherein the interface is connected to a transmission node which relays data traffic between the interface of the first device and the interface of the second device.

8. The computer-implemented method of claim 1, wherein the interface is connected to a network and the plurality of requests are sent to the interface of the remotely located second device via the network.

9. A system comprising:
an interface of a first device, wherein the interface is to:
signal descriptive information about requests for which the interface receives no positive indication that the requests have been successfully processed by a second device to a fuzzy logic engine, wherein the fuzzy logic engine is to persistently store fuzzy membership functions and fuzzy inference rules;
receive in response to the signaled information request ordering information from the fuzzy logic engine; and
resend the requests in accordance with an order indicated by the ordering information.

10. The system of claim 9, wherein the ordering information contains indications of crisp values calculated by the fuzzy logic engine.

11. The system of claim 9, wherein the descriptive information contains an indication of an urgency of each request.

12. The system of claim 9, wherein the descriptive information contains an indication of a category of each respective request.

13. The system of claim 12, wherein values of a plurality of membership functions of each request are based on the number of not successfully processed requests in the same category.

14. A machine-readable medium storing non-transitory machine-readable instructions which when executed by a processor of a first device cause a workflow within the first device to:
send a multitude of requests to a second device, each request of the plurality of requests indicating an action of a list of actions to be performed by the second device, the list of actions comprising at least one of a create, delete, update, close, and reopen action with regard to a record in a memory of the second device;
determine that at least some of the plurality of requests have not successfully been processed by the second device;
determine an order of at least some of the not successfully processed requests for resending based on a fuzzy logic implementation; and
resend the ordered requests.

15. The machine-readable medium of claim 14, wherein the workflow within the first device is further caused to:
determine descriptive information about the requests for which the interface receives no positive indication that the requests have been successfully processed by the second device;
implement a fuzzy logic engine, wherein the fuzzy logic engine is to persistently store fuzzy membership functions and fuzzy inference rules; and
use the fuzzy logic engine to provide ordering information for determining the order of the not successfully processed requests based on the descriptive information.
